(19) United States
(12) Patent Application Publication
(10) Pub. No.: US 2011/0078084 A1
(43) Pub. Date: Mar. 31, 2011

(54) System And Process Of Warranty Management

(75) Inventor: Amit Gupta, Mount Zion, IL (US)

(73) Assignee: CARRIER CORPORATION, Farmington, CT (US)

(21) Appl. No.: 12/879,177

(22) Filed: Sep. 10, 2010

Related U.S. Application Data
(60) Provisional application No. 61/241,220, filed on Sep. 10, 2009.

(51) Int. Cl. G06Q 99/00

(52) U.S. Cl. 705/302

(57) ABSTRACT

A system for adjudicating a claim of warranty to a product comprises a policy processing module, title processing module, and a warranty processing module. The policy processing module processes rules and policy regarding the adjudication of claims of warranty to a product associated with property that has recordable title. The title processing module processes title information from a database containing recorded title information for the property. The warranty processing module processes the claim of warranty as a function of the rules and policy processed by the policy processing module and the title information processed by the title processing module to produce a warranty adjudication output that allows or denies the claim of warranty to the product.

### CROSS-REFERENCE TO RELATED APPLICATIONS

This application is a non-provisional patent application which claims the benefit of U.S. provisional patent application Ser. No. 61/241,220 filed Sep. 10, 2009, the entire contents of which are incorporated herein by reference.

### BACKGROUND

Some warranties stipulate that the terms of the warranty only extend to the original purchaser of the product under warranty so long as the original purchaser owns the product, or for some established length of time. This stipulation is often contained in a clause in the warranty that may commonly be referred to as an original purchaser clause. Under such a clause, when the original purchaser subsequently resells or transfers title in the product to another, the warranty is voided. However, new owners of the product are typically not informed by the original purchaser of the terms of the warranty, and many new owners assume the warranty transfers along with the sale or transfer of title or ownership in the product. Furthermore, the warrantor is typically not informed when the product has been resold. This misinformation on the part of the new owner and lack of communication to the warrantor leads to numerous problems and costs for both parties.

For example, a new owner of the product who is uninformed or misinformed regarding the terms of the warranty may submit a claim to the warrantor asking for reimbursement for repairs or parts, even though the new owner is not entitled to reimbursement. The warrantor must then adjudicate the claim by exercising all clauses in the warranty, including the original purchaser clause. However, determining whether the claimant is the original purchaser is often difficult when the warrantor of the product was not informed that the product had been resold. Furthermore, it is often the case that the original purchaser has not registered the original purchaser's information with the warrantor such that it can be compared to the claimant's information to verify whether the claimant is the original purchaser. Even in situations where the product was registered, further difficulties arise when the claimant is not recorded as the original purchaser even though the claimant is acting on behalf of the original purchaser (e.g., a spouse living in the same household), and thus the claim may sometimes be unfairly rejected even though the warranty should apply to that product because the original purchaser still retains ownership of it. When a claim of warranty is unfairly rejected, it can lead to further efficiency costs when the claimant disputes the decision with the warrantor, and can also lead to poor customer relations.

Another problem arising from warranties containing an original purchaser clause is there is no reliable mechanism by which the subsequent purchaser of a product may be notified of the voided warranty and possible opportunities to purchase a new warranty, for example. Additionally, because the warrantor is not notified when a product has been resold, the warrantor must presume the warranty is still in force for all products until notified otherwise, and will keep a liability account to cover the potential expenses it estimates to exist for those products. However, this presumption results in an inflated liability account and reduces the available money the warrantor could use for other expenses.

### SUMMARY

A system for adjudicating a claim of warranty to a product comprises a policy processing module, title processing module, and a warranty processing module. The policy processing module processes rules and policy regarding the adjudication of claims of warranty to a product associated with property that has recordable title. The title processing module processes title information from a database containing recorded title information for the property. The warranty processing module processes the claim of warranty as a function of the rules and policy processed by the policy processing module and the title information processed by the title processing module to produce a warranty adjudication output that allows or denies the claim of warranty to the product.

In another embodiment, a process for adjudicating a claim of warranty having an original purchaser clause comprises receiving the claim of warranty arising from a product that is associated with property that has recordable title, retrieving title information for the property to determine a last date of title change for the property, and denying the claim of warranty if the last date of title change is between a date of installation or purchase of the product and a date of claim of warranty or repair of the product.

In yet another embodiment, a system for determining the viability of warranty coverage comprises a policy processing module, a title processing module, and a warranty processing module. The policy processing module processes rules and policy regarding a warranty covering a product associated with property that has recordable title. The title processing module processes title information from a database containing recorded title information for the property. The warranty processing module processes the viability of warranty coverage as a function of the rules and policy processed by the policy processing module and the title information processed by the title processing module to produce an output that the warranty is active or that the warranty is void for the product associated with the property.

In yet another embodiment, a process for determining the viability of warranty coverage for a warranty having an original purchaser clause comprises activating the warranty for a product associated with property that has recordable title, processing title records for the property to determine if a change in title to the property has occurred, and determining the warranty is void if the change in title to the property has occurred since the warranty was activated.

### BRIEF DESCRIPTION OF THE DRAWINGS

FIG. 1 is a schematic diagram of a warranty claim adjudication system.

FIG. 2 is a flow diagram of a process performed by the system of FIG. 1 for adjudicating a claim of warranty.

FIG. 3 is a flow diagram of a process performed by the system of FIG. 1 for determining the viability of a warranty.

### DETAILED DESCRIPTION

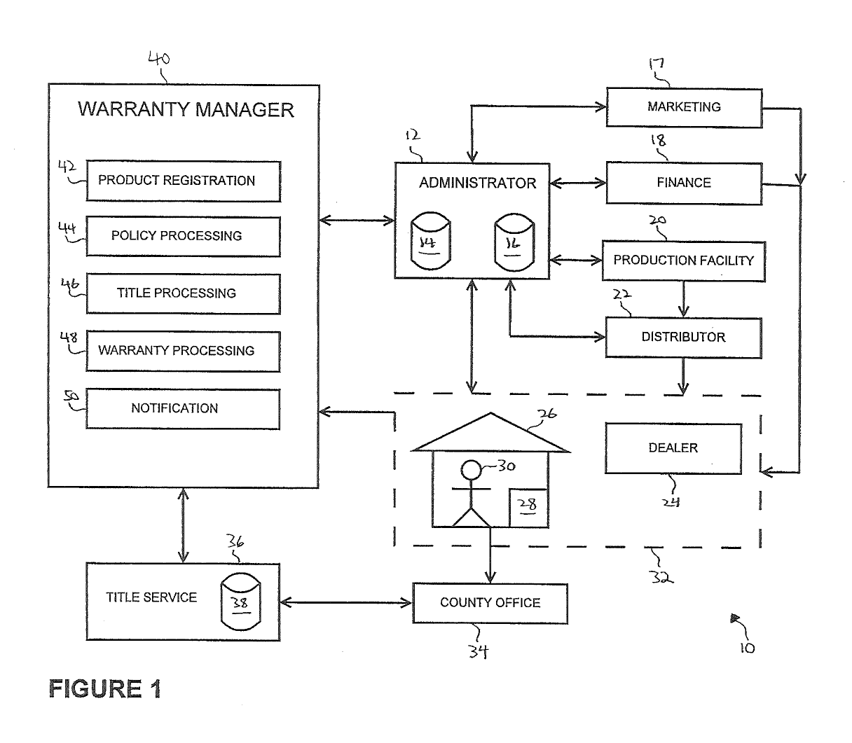

FIG. 1 shows system 10 for adjudicating claims of warranty containing, having administrator 12 having product history database (PHDB) 14 and policy database 16; marketing 17; finance 18; production facility 20; distributor 22; dealer 24; property 26 having product 28 and resident 30; claimant 32; county office 34; title service 36 having title database 38; and warranty manager system 40 having product registration module 42, policy processing module 44, title processing module 46, warranty processing module 48, and notification module 50. The warranty manager system 40 may be implemented on a computer or server executing a computer program stored on a computer readable medium to implement the processing described herein. Modules 42, 44, 46, 48 and 50 maybe implemented by the warranty manager system 40 executing a computer program stored on a computer readable medium to implement the processing described herein. Although shown as independent sub-entities or components of system 10, it may be appreciated that one or more of production facility 20, administrator 12, warranty manager 40, title service 36, marketing 17, finance 18, distributor 22 and dealer 24 may be part of the same corporate entity, for example.

Production facility 20 produces product 28 having a model number or name and serial number. Product 28 is shipped to distributor 22, who eventually distributes product 28 to dealer 24. Dealer 24 then sells and/or installs product 28 on or in property 26. Alternatively, distributor may distribute and sell product 28 directly to the original purchaser, who may then either personally install product 28 on or in property 26 or may hire a contractor to do so. Product 28 is shown as a fixture of property 26 that is firmly fixed in place and typically belongs to property 26 when it is sold. Examples of fixtures include but are not limited to temperature and air quality systems such as heating, ventilation and air conditioning (HVAC) systems, geothermal heating and cooling systems, UV sterilization units, filters, humidity controllers, and thermostats; energy generation systems such as solar panels, windmills or turbines; plumbing and associated components such as sinks, toilets, bathtubs, faucets and pumps; security systems; electrical systems and components such as wiring, light fixtures, breaker boxes, and switches; elevator and escalator systems; and hardware such as locks, cabinets, doors, windows, roofing, and fences. Property 26 is shown as real property, for example, commercial or residential. However, it may be appreciated that the system and process of the present invention would work for any kind of product associated with property that has recordable title, so long as it is typically the case that title in the product will be transferred with the transfer of title in the property.

Title service system 36 monitors the transfer of title in property 26 by accessing county office 34 records, and stores information regarding property 26 in title database 38, accessible by warranty manager 40. The title service system 36 may be implemented on a computer or server executing a computer program stored on a computer readable medium to implement the processing described herein. Information including but not limited to the address of property 26, the date of each change in title to property 26, and the name and other identifying information of the owner or title holder of property 26 is stored in title database 38. Owner information for property 26 is kept up to date in title database 38 by real time monitoring of county office 34 records by title service 36.

Administrator system 12 administrates the functions of warranty manager 40 to adjudicate claims of warranty to product 28 and process warranty viability for product 28. The administrator system 12 may be implemented on a computer or server executing a computer program stored on a computer readable medium to implement the processing described herein. Administrator system 12 has databases 14, 16 for the storage of information, including information either necessary or useful for the adjudication of warranty claims by warranty manager 40. PHDB 14 is used for the storage of information relating to product 28, including but not limited to information regarding the model of product 28, its serial number, distributor 22 and dealer 24 identifying information, the date product 28 was shipped from production facility 20 to distributor 22 and from distributor 22 to dealer 24, as well as the date of purchase and/or installation of product 28 into property 26. Where an installation date and purchase date for product 28 have not been provided by dealer 24 to administrator 12, then a default date of purchase and/or installation may be established relative to the known date of manufacture of product 28 in production facility 20. For example, 6 months from the date of manufacture of product 28 could be set as the date of purchase and/or installation of product 28 for storage in PHDB 14 and later use in adjudicating claims of warranty. PHDB 14 may also include registrant information in a situation where product 28 has been registered, including but not limited to the name of an original purchaser of product 28, the address of property 26 where product 28 was installed, the phone number and e-mail address of the original purchaser, and the date of purchase and/or installation. Furthermore, any information relating to warranty adjudication or viability for product 28 may be provided by warranty manager 40 to administrator 12 for storage in PHDB 14.

Policy database 16 stores information relating to warranty policy, including but not limited to the operative clauses and language contained in the warranty for product 28, for example, an original purchaser clause, and the rules to be used for adjudicating a claim of warranty to product 28. Information stored on policy database 16 is created and controlled by administrator 12, and is provided to warranty manager 40 to govern the adjudication of claims of warranty and the processing of warranty viability for product 28.

Claimant 32 is whoever submits a claim of warranty to product 28, and may or may not be the original purchaser of product 28. Claimant 32 could include resident 30 who lives in or on property 26 having product 28 fixed to the property, for example. Resident 30 could be an owner of property 26 who may or may not be the original purchaser of product 28. Claimant 32 might also include dealer 24 of product 28 who submits a claim of warranty on behalf of resident 30, seeking reimbursement for repairs performed on product 28.

Warranty manager 40 serves multiple functions, generally including the adjudication of claims of warranty to product 28 received from claimant 32, the processing of the viability of warranty coverage for product 28, the processing of registrant information, and the communication of information to administrator 12. Warranty manager 40 comprises modules including but not limited to product registration 42, policy processing 44, title processing 46, warranty processing 48, and notification 50 modules for adjudicating claims of warranty and processing warranty viability for product 28. Modules 42, 44, 46, 48, 50 may be implemented on a machine with a combination of hardware and software. For example, the modules may be implemented on a general purpose computer or mainframe computer. The implementation of modules 42, 44, 46, 48, 50 may be fully automated or may involve user input via a display unit and data input interface such as a keyboard and mouse, for example.

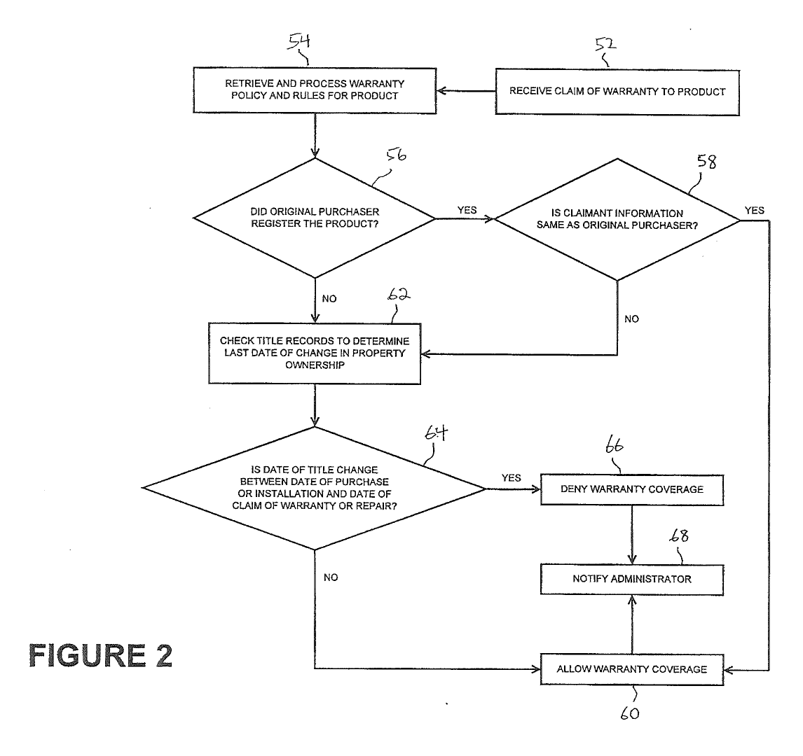

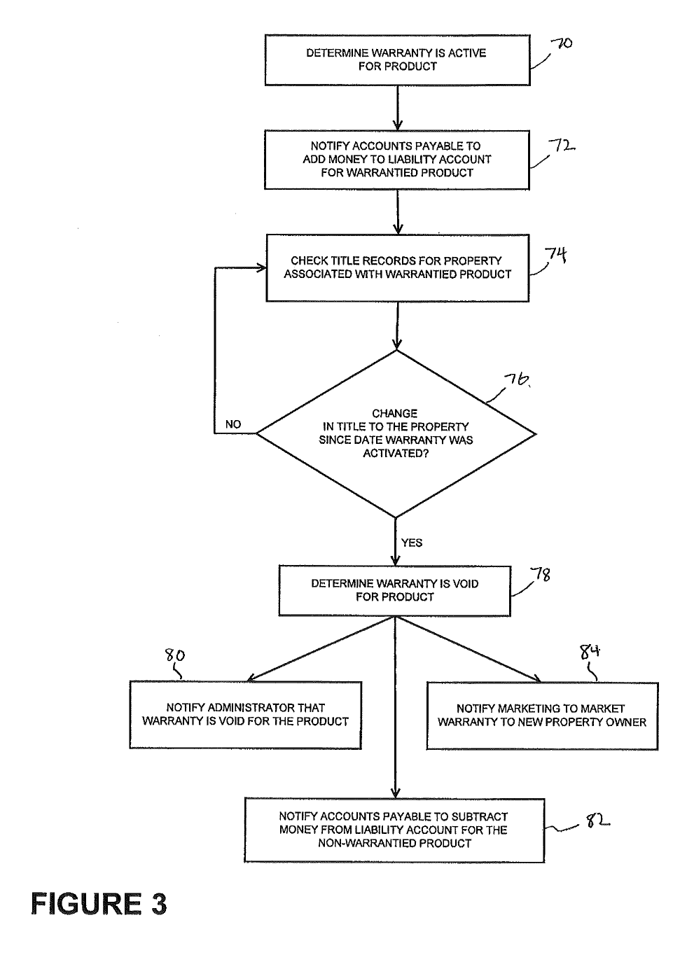

Product registration module 42 functions to process registration information received from an original purchaser of product 28 and communicate this information to administrator 12 for storage in PHDB 14. Product registration module may also retrieve product 28 registration information from PHDB 14 for use by warranty processing module 48. Policy processing module 44 functions to retrieve rules information from policy database 16 covering the processing of warranty viability and the adjudication of a claim of warranty to product 28 for use by warranty processing module 48. This may include, for example, an original purchaser clause and other operative language and clauses in the warranty that need to be adjudicated for product 28. This may further include specific guidelines provided by administrator 12 detailing the rules by which a warranty claim should be adjudicated or warranty viability processed for product 28 versus other products and warranties specific to those products. Title processing module 46 functions to retrieve and process information associated with property 26 including the date of change in title to property 26, and the name of the current and previous owners of property 26 from title database 38. This information may be processed for use by warranty processing module 48 to adjudicate a claim of warranty to product 28 as described with reference to FIG. 2, or to process the viability of a warranty covering product 28 as described with reference to FIG. 3.

Warranty processing module 48 functions to adjudicate warranty coverage for product 28, for example, by adjudicating claims of warranty as described with reference to FIG. 2, and by the processing of warranty viability as described with reference to FIG. 3. For some operations, warranty processing module 48 may retrieve information directly from PHDB 14 for use in adjudicating claims of warranty or processing warranty viability for product 28. Warranty processing module 48 also interacts with and receives information from product registration module 42, policy processing module 44, and title processing module 46 to process information from these modules and produce a warranty adjudication output or warranty viability output for product 28. For example, to adjudicate operative clauses in a claim of warranty to product 28, warranty processing module 48 may apply rules for adjudicating warranty clauses received from policy processing module 44, and processes information contained in a claim of warranty to product 28 along with registrant information from product registration module 42 and property 26 information from title processing module 46 to produce an output that warranty coverage is allowed or denied for a particular claim. Alternatively, warranty processing module 48 may process the viability of a warranty covering product 28 even when a claim of warranty has not been submitted, utilizing information processed by policy processing module 44 and title processing module 46, for example, to produce an output that the warranty is active or void for product 28.

Notification module 50 functions to process the output provided by warranty processing module 48, identify whether it is a warranty adjudication output or a warranty viability output, and provide an output to notify the appropriate entity of the information received from warranty processing module 48. For example, as described in more detail with reference to FIG. 2, notification module 50 may process a warranty processing module 48 output, determine it is a warranty adjudication output, and notify administrator of pertinent information, including storing the output and any processed information relating to the claim of warranty and its resolution in PHDB 14. This could include, for example, the date the claim was made, serial number and model of product 28, date of repair, type of repair, parts used for the repair, claimant 32 identifying information, whether warranty coverage was allowed or denied, and the date of the decision. This information may then be stored in PHDB 14 by administrator 12, or may be directly entered into PHDB 14 by notification module 50, and may be useful to administrator 12 for the future adjudication of warranty claims for product 28. Notification module 50 may also notify finance 18 of the warranty adjudication output either directly or indirectly through administrator 12. As described in more detail with reference to FIG. 3, notification module 50 may process an output provided by warranty processing module 48, determine that it is a warranty viability output indicating that a warranty for product 28 is active or void, and notify administrator 12, marketing 17, and/or finance 18 of pertinent information for their use. For example, the notification output may indicate to finance 18 that a liability account for warranties to product 28 needs to be adjusted, or may indicate to marketing 17 that a new or extended warranty should be marketed to a new title holder or resident 30 or property 26.

Finance 18 receives pertinent information from warranty manager 40 or via administrator 12 regarding warranty adjudication decisions and active and voided warranties for product 28. As described in more detail with reference to FIG. 2, if a warranty adjudication decision is favorable to claimant 32, finance 18 triggers a reimbursement to claimant 32 according to the terms of the warranty for product 28. This may include, for example, reimbursement for a failed component of product 28, or labor involved in repairing product 28. As described in more detail with reference to FIG. 3, when finance 18 is notified by warranty manager 40 that a warranty to product 28 becomes active, it adds an amount to a liability account to cover potential expenses that could be incurred in covering the warranty for product 28. When finance 18 is notified by warranty manager 40 that a warranty to product 28 is void, it subtracts the amount it previously added to the liability account to free it up for other uses.

Marketing 17 receives information from warranty manager 40 or via administrator 12 regarding warranty adjudication decisions and voided warranties for product 28. If marketing 17 receives a notification that the warranty covering product 28 is void, or that a claim of warranty was not allowed, marketing 17 is notified to market a new or extended warranty to the new title holder or resident 30 of property 26.

FIG. 2 is a flow diagram of an embodiment of the present disclosure showing the operation of warranty manager 40 for processing a claim of warranty to product 28 for an original purchaser clause. Warranty manager 40 receives a claim of warranty from claimant 32 arising from product 28 associated with property 28 that has a recordable title (step 52). In the embodiment shown in FIG. 2, property 28 is real property, and product 28 is a fixture of the real property. Because product 28 is a fixture of property 26, an owner of property 26 may or may not be the original purchaser of product 28 depending on whether property 26 has been sold since the original purchase of product 28. Fixtures of properties are very rarely removed from a property when it is sold, and therefore it may be presumed that a subsequent owner of property 26 having product 28 installed will not be the original purchaser of product 28. Furthermore, resident 30 may or may not be the owner of property 26, yet could submit a claim of warranty to product 28 that would be valid as long as the original purchaser still owns product 28 (i.e., still owns property 26). Whether dealer 24 submits the claim of warranty to product 28 on behalf of resident 30, owner of property 26, or someone other than these parties submits the claim of warranty, the original purchaser clause must be adjudicated to ascertain whether warranty coverage is allowed (step 60) or denied (step 66) for claimant 32 with respect to product 28 in or on property 26.

To adjudicate whether warranty coverage should be allowed or denied for claimant 32, warranty processing module 48 applies rules retrieved from policy database 16 by policy processing module 44 specific for product 28 (step 54). For the process shown in FIG. 2, policy processing module 44 retrieves an original purchaser clause as part of the policy covering product 28 and processes this clause for use by warranty processing module 48. To adjudicate this clause, warranty processing module 48 communicates with product registration module 42 to determine whether the original purchaser registered product 28 (step 56). If the original purchaser registered product 28, then warranty processing module 48 processes product 28 registration information provided by product registration module 42 to determine whether identifying information for claimant 32 is the same as registered identifying information for the original purchaser of product 28 having a specific serial number (step 58). If the information is the same, then the warranty coverage requested by claimant 32 is for the original purchaser of product 28, and warranty processing module 48 concludes warranty coverage should be allowed for product 28 (step 60) and provides an output indicating this result. Identifying information includes but is not limited to one or a combination of name, birth date, social security number, driver's license ID, an answer to a secret question, e-mail address, or any other information that may reliable identify whether claimant 32 is the original purchaser of product 28.

If the original purchaser did not register product 28, or claimant 32 identifying information is different from registered original purchaser information (e.g., someone other than the original purchaser submits the claim of warranty to product 28 and does not identify the original purchaser), warranty manager 40 must determine whether the original purchaser still owns product 28 from which a claim of warranty has arisen. Under an original purchaser clause, warranty coverage should not be denied for product 28 so long as the original purchaser still owns product 28, regardless of who submits the claim of warranty or whether the original purchaser registered product 28. However, warranty coverage will be denied for product 28 if ownership of product 28 has changed since the original purchaser purchased it.

To determine whether the original purchaser still owns product 28 to which a claim of warranty is being asserted by claimant 32, warranty processing module 48 interacts with title processing module 46 to process information regarding the ownership of property 26 having product 28 as a fixture. Title processing module 46 checks title records in title database 38 to determine the last date of change in property 26 ownership (step 62) and provides an output to warranty processing module 48. Warranty processing module 48 then processes this information to determine whether the date of title change for property 26 is between a date of purchase or installation of product 28 in or on property 26 and a date of claim of warranty or repair for product 28 (step 64). A date of claim of warranty for product 28 may be the date the claim was submitted or signed, for example. Warranty processing module 48 furthermore retrieves purchase date and installation date information from PHDB 14. If the date of title change for property 26 lies between the date of purchase or installation of product 28 and the date of claim of warranty or repair of product 28, this indicates that the original purchaser is no longer the owner or resident 30 of property 26, and therefore it may be implied that the original purchaser no longer owns product 28. Consequently, warranty processing module 48 concludes that claimant 32 is not the original purchaser because the claim of warranty does not arise from a product 28 still owned by the original purchaser, and provides an output that warranty coverage is denied (step 66). If the date of title change for property 26 does not exist or does not lie between the date of purchase or installation of product 28 and the date of claim of warranty or repair, then it is presumed that the original purchaser owned product 28 fixed to property 26 when the claim or repair was made. Consequently, warranty processing module 48 provides an output that warranty coverage is allowed (step 60) for product 28 fixed to property 26.

Once warranty processing module 48 has provided an output that warranty coverage is denied (step 66) or allowed (step 60), notification module 50 processes the output and provides its own output to notify administrator 12 of the decision (step 68), including any relevant information regarding product 28 and claimant 32 information. This could include, for example, the date the claim was made, serial number and model of product 28, date of repair, type of repair, parts used for the repair, claimant 32 identifying information, whether warranty coverage was allowed or denied, and the date of the decision. This information may then be stored in PHDB 14 by administrator 12, or may be directly entered into PHDB 14 by notification module 50. Notification module 50 may also provide an output to notify finance 18 of the warranty adjudication decision either directly or indirectly through administrator 12. Furthermore, notification module 50 may provide an output to notify marketing that warranty coverage was denied for product 28 and to market new or extended warranty coverage to the new owner or resident 30 of property 26.

FIG. 3 is a flow diagram of an embodiment of the present disclosure showing the operation of warranty manager 40 for processing the viability of a warranty to product 28, including an original purchaser clause. Warranty processing module 48 determines that a warranty for product 28 is active (step 70) and provides an output to indicate this. A warranty may become active, for example, on the date of purchase, installation, or registration of product 28. Purchase, installation, and registration information may be retrieved from PHDB 14 by warranty processing module 48. The appropriate warranty applicable for product 28 and rules for processing its viability may be retrieved by warranty processing module 48 from policy database 16. Notification module 50 processes the output from warranty processing module 48 and provides its own output to notify finance 18 to add an amount to a liability account for potential warranty claims involving the now warrantied product 28 (step 72). This notification may either be sent directly to finance 18 or via administrator 12, for example. Title processing module 46 checks title records for property 26 associated with warrantied product 28 (step 74) and processes them for warranty processing module 48. Title processing module 46 may access title database 38, for example, to retrieve the most current title information for property 26. Warranty processing module 48, applying the rules retrieved from policy database 16 including the original purchaser clause, then determines if a change in title to property 26 has occurred since the date the warranty became active (step 76). If a change in title to property 26 has not occurred since the date the warranty became active, then title processing module continues to check title records for property 26 periodically (step 74). If a change in title to property 26 has occurred since the date the warranty became active, it provides an output indicating this for warranty processing module 48. Warranty processing module 48, applying the rules retrieved from policy database 16 including the original purchaser clause, then determines that the warranty is void for product 28 (step 78) and provides an output to indicate this.

Notification module 50 processes the output from warranty processing module 48, identifies it to be a warranty viability output, and provides its own output to notify administrator 12 that the warranty is void for product 28 (step 80). This information may then be stored in PHDB 14. Notification module 50 also notifies finance 18 to subtract from the liability account the amount allocated for warranty claims relating to product 28 (step 82) and notifies marketing 17 to offer a new warranty or extended warranty to the new owner or resident 30 of property 26 (step 84). Notification of finance 18 and marketing 17 may either be sent directly, or via administrator 12, for example.

As an alternative to the process described with reference to FIG. 2, if a claim of warranty is received from claimant 32 after the determination that the warranty is void by the process of FIG. 3, warranty processing module 48 may retrieve and process this information from PHDB 14 and consequently deny warranty coverage for product 28.

It may be appreciated that the system and process of the present disclosure has numerous benefits, including the ability to reliably adjudicate original purchaser clauses of warranties arising from product 28 regardless of who claimant 32 is so long as property 26 having product 28 as a fixture may be identified. This results in a large cost savings for the warrantor because claims of warranty arising from product 28 where the original purchaser no longer retains ownership of it may reliably be denied. Furthermore, claims of warranty where claimant 32 identifying information is not the same as original purchaser information are not automatically rejected under the system and process of the present disclosure. This allows warranty coverage to be properly extended in those cases where the original purchaser still retains ownership of product 28 even though someone else may have submitted the claim of warranty without identifying the original purchaser on the claim. By properly adjudicating original purchaser clauses under the system and process of the present disclosure, customer satisfaction is increased as well as efficiency savings by eliminating the need to process and adjudicate disputed improper warranty decisions.

Additionally, the system and process of the present disclosure offers further cost savings of great magnitude by enabling the continual processing of the viability of a warranty to product 28. This allows finance 18 to have an accurate estimate of the liability existing for each product 28 at any given time, thereby preventing the inflation of liability accounts and freeing up money to be used for other operating expenses. Furthermore, this information allows marketing 84 to know when the opportune moment exists to market a new or extended warranty covering product 28 for a new owner of property 26 or its resident 30, thereby generating revenue and preventing consumers from being misinformed about warranty coverage to product 28.

Although the system and process have been described in the context of products associated with real property, it may be appreciated that the system and process of the present invention would work for any kind of product associated with property that has recordable title, so long as it is typically the case that title in the product will be transferred with the transfer of title in the property. As an example, warranties on motor vehicles and their components and systems are also possible. Like real property, motor vehicles (e.g., automobiles, boats, off-road vehicles, motorcycles, snowmobiles, and aircraft) are the subject of recorded title documents.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A system for adjudicating a claim of warranty to a product, comprising:
a policy processing module for processing rules and policy regarding the adjudication of claims of warranty to a product associated with property that has recordable title;
a title processing module for processing title information from a database containing recorded title information for the property; and
a warranty processing module for processing the claim of warranty as a function of the rules and policy processed by the policy processing module and the title information processed by the title processing module to produce a warranty adjudication output that allows or denies the claim of warranty to the product.

2. The system of claim 1, wherein the policy includes an original purchaser clause.

3. The system of claim 2, wherein the title processing module determines a last date of title change for the property.

4. The system of claim 3, wherein the warranty processing module produces a warranty adjudication output that denies the claim of warranty to the product if the last date of title change for the property is between a date of installation or purchase of the product and a date of claim of warranty or repair of the product.

5. The system of claim 3, wherein the warranty processing module produces a warranty adjudication output that allows the claim of warranty if the last date of title change for the property does not exist or if the last date of title change for the property is not between a date of installation or purchase of the product and a date of claim of warranty or repair of the product.

6. The system of claim 1, wherein the property is real property.

7. The system of claim 6, wherein the product is a fixture of the real property.

8. The system of claim 7, wherein the product is selected from a group consisting of heating, ventilation and air conditioning (HVAC) systems, geothermal heating and cooling systems, UV sterilization units, filters, humidity controllers, thermostats, solar panels, windmills, turbines, plumbing, sinks, toilets, bathtubs, faucets, pumps, security systems, electrical wiring, light fixtures, breaker boxes, switches, locks, cabinets, doors, windows, roofing, and fences.

9. The system of claim 1, wherein the property is a motor vehicle.

10. The system of claim 9, wherein the product is a component of the motor vehicle.

11. The system of claim 1, wherein the policy processing module retrieves rules and policy information from a database maintained by an administrator of the system.

12. The system of claim 1, wherein the title processing module retrieves title information for the property from a database maintained by a title service.

13. The system of claim 12, wherein the title service retrieves ownership information for the real property from a county office.

14. The system of claim 1, further comprising a product registration module for processing registration information regarding the product.

15. The system of claim 14, wherein the warranty processing module processes the claim of warranty further as a function of the registration information processed by the product registration module.

16. The system of claim 15, wherein the warranty processing module determines if the registrant information is the same as identifying information for a claimant who submits the claim of warranty.

17. The system of claim 16, wherein the warranty processing module produces a warranty adjudication output that allows warranty coverage if the registrant information is the same as the identifying information for the claimant who submits the claim of warranty to the product.

18. The system of claim 1, further comprising a notification module for processing the warranty adjudication output from the warranty processing module to allow or deny the claim of warranty and producing an output to notify at least one of an administrator, finance, and marketing of the warranty adjudication output.

19. The system of claim 18, wherein the output produced by the notification module includes information selected from a group consisting of the date the claim was made, serial number of the product, model of the product, date of repair of the product, type of repair of the product, parts used for the repair of the product, claimant identifying information, whether warranty coverage was allowed or denied, and the date of the warranty adjudication output from the warranty processing module.

20. A system for determining the viability of warranty coverage, comprising:
a policy processing module for processing rules and policy regarding a warranty covering a product associated with property that has recordable title;
a title processing module for processing title information from a database containing recorded title information for the property; and
a warranty processing module for processing the viability of warranty coverage as a function of the rules and policy processed by the policy processing module and the title information processed by the title processing module to produce an output that the warranty is active or that the warranty is void for the product associated with the property.
